(19) United States
(12) Patent Application Publication
(10) Pub. No.: US 2026/0074805 A1
(43) Pub. Date: Mar. 12, 2026

(54) ADAPTIVE FILTERING ALGORITHM FOR UNDERWATER ACOUSTIC CHANNEL ESTIMATION

(71) Applicant: Northwestern Polytechnical University, Xi 'an (CN)

(72) Inventors: Honglei WANG, Xi 'an (CN); Huizhong YANG, Xi 'an (CN); Yixin YANG, Xi 'an (CN)

(73) Assignee: Northwestern Polytechnical University, Xi 'an (CN)

(21) Appl. No.: 19/023,353

(22) Filed: Jan. 16, 2025

(30) Foreign Application Priority Data
Sep. 6, 2024 (CN) 202411249109.9

(51) Int. Cl. H04B 13/02; H04L 25/02

(52) U.S. Cl. CPC H04B 13/02; H04L 25/024

(57) ABSTRACT

An adaptive filtering algorithm for underwater acoustic channel estimation belongs to the technical field of underwater acoustic channel estimation. The idea of proportional matrix and data reuse is introduced to compute the proportional coefficient corresponding to each tap in each iteration, thereby improving the applicability of the algorithm in a sparse environment; and the accumulated error term is obtained by reusing the input signal and the desired signal within the same time, further improving the accuracy of the algorithm. The accuracy of the recursive least squares algorithm is improved in the sparse environment, which is helpful to the efficient development of underwater acoustic communication research.

### CROSS REFERENCE TO THE RELATED APPLICATIONS

This application is based upon and claims priority to Chinese Patent Application No. 202411249109.9, filed on Sep. 6, 2024, the entire contents of which are incorporated herein by reference.

### TECHNICAL FIELD

The present disclosure relates the field of underwater acoustic channel estimation technology, particularly to an adaptive filtering algorithm for underwater acoustic channel estimation.

### BACKGROUND

In contrast to terrestrial wireless communication, the quality of underwater acoustic communication is severely affected by multipath effect and delay spread, leading to a major challenge to the robustness of underwater data transmission. It is helpful to eliminate the adverse effects of the channel by efficiently predicting the channel impulse response coefficient, thereby accurately recovering the transmitted signal at the receiving end. Therefore, it is necessary to design the channel estimation algorithm efficiently.

There are two common adaptive filtering algorithms for channel estimation: the least mean square algorithm and the recursive least square algorithm. The least mean square algorithm has low computational complexity and is easy to implement, but the selection of its step size requires a trade-off between convergence speed and stability, which is usually limited in practical applications; the recursive least squares algorithm has better convergence speed than the least mean square algorithm, and has the higher filtering accuracy, which can quickly adjust the weight to achieve the lowest error in a dynamic environment, so the recursive least squares have been widely used.

However, underwater acoustic channels have a unique sparse property, which is characterized by the fact that the energy in the channel is concentrated on a few taps, and the impulse response coefficients of most other channels are zero or close to zero. It is helpful to eliminate interference noise and unimportant taps in the channel by accelerating the convergence of these zero coefficients, the larger coefficients are preserved and allow them to converge to true values as quickly as possible. Additionally, the conventional adaptive filtering algorithm only uses the input signal vector and the desired signal once within the same time. Therefore, it is necessary to propose an adaptive filtering algorithm for underwater acoustic channel estimation.

### SUMMARY

In order to avoid the shortcomings of the existing technology, the present application provides an adaptive filtering algorithm for underwater acoustic channel estimation, which is used to solve the problem in the existing technology that only a few taps have large values due to the inherent sparsity in the underwater acoustic channel, and the conventional recursive least squares algorithm has limited gain in this condition.

According to the embodiment of the present disclosure, an adaptive filtering algorithm for underwater acoustic channel estimation is provided, which includes:
acquiring a transmitted signal and a received signal, and taking the received signal and the transmitted signal corresponding to an n^{th} time as an input signal at the n^{th} time and a desired signal at the n^{th} time, respectively; wherein a preset length of the input signal at the n^{th} time is L;
obtaining a filter gain vector at the n^{th} time according to a filter coefficient matrix at an n−1^{th} time and the input signal at the n^{th} time;
obtaining the filter coefficient matrix at the n^{th} time according to the filter coefficient matrix at the n−1^{th} time, the filter gain vector at the n^{th} time and the input signal at the n^{th} time;
obtaining a prior error at the n^{th} time according to the desired signal at the n^{th} time, the input signal at the n^{th} time and a weight at the n−1^{th} time;
obtaining a diagonal matrix at the n−1^{th} time based on a proportional matrix in a data-reusing proportion recursive least squares algorithm and combining a proportional coefficient of activity at the n−1^{th} time;
obtaining an error accumulation term at the n^{th} time based on an idea of data reuse in the data-reusing proportion recursive least squares algorithm and combining the input signal at the n^{th} time and the desired signal at the n^{th} time;
obtaining the weight at the n^{th} time according to the weight at the n−1^{th} time, the diagonal matrix at the n−1^{th} time, the filter gain vector at the n^{th} time, the error accumulation term at the n^{th} time and the prior error at the n^{th} time; and
repeating the above steps to iteratively compute the weight at a next time until the computation is completed.

Further, the computation expression of the filter gain vector at the n^{th} time is as follows:

$$k ( n ) = \frac{{λ}^{- 1} {R}^{- 1} ( n - 1 ) x ( n )}{1 + {λ}^{- 1} {x}^{H} ( n ) {R}^{- 1} ( n - 1 ) x ( n )} \qquad ( 10 )$$

where λ is a forgetting factor, and 0<<λ<1, R(n−1) is the coefficient matrix of the filter at the n−1^{th} time, x(n) is the input signal at the n^{th} time, and (⋅)^{H} is a conjugate transpose.

Further, the computation expression of the filter coefficient matrix at the n^{th} time is as follows:

$${R}^{- 1} ( n ) = {λ}^{- 1} [ {R}^{- 1} ( n - 1 ) - k ( n ) {x}^{H} ( n ) {R}^{- 1} ( n - 1 ) ] \qquad ( 11 )$$

where k(n) is the filter gain vector at the n^{th} time.

Further, the computation expression of the prior error at the n^{th} time is as follows:

$$e ( n ) = u ( n ) - {w}^{H} ( n - 1 ) x ( n ) \qquad ( 12 )$$

where w(n−1) is the weight at the n−1^{th} time, and u(n) is the transmitted signal at the n^{th} time.

Further, the expression of the diagonal matrix at the n−1^{th} time is as follows:

$$D ( n - 1 ) = μdiag \{ {d}_{i} ( n - 1 ) \} , i = 1 , 2 , … , L \qquad ( 1 )$$

where D(n−1) is the diagonal matrix at the n−1^{th} time, the magnitude is L×L, L is a channel length, is a control parameter, and the value range of μ is (0, L], dᵢ(n−1) is an activity proportional coefficient at the n−₁^{th} time, the computation expression of dᵢ(n−1) is as follows:

$${d}_{i} ( n - 1 ) = \frac{1 - a}{2 L} + \frac{( 1 + a ) \vert {w}_{i} ( n - 1 ) \vert}{2 {‖ {w}_{L} ( n - 1 ) ‖}_{1} + ϵ} \qquad ( 2 )$$

where (1−a)/2L is a fixed proportional coefficient, a∈[−1,1) is a balance parameter, e is a positive constant, ∥⋅∥₁ is a 1-norm, w_{L}(n−1) is an estimated channel impulse response vector at the n−1^{th} time, the magnitude is L×1, and wᵢ(n−1) is an i^{th} element in w_{L}(n−1).

Further, the computation expression of the error accumulation term at the n^{th} time is as follows:

$$ϕ ( n ) = \frac{1 - {θ}^{m} ( n )}{1 - θ ( n )} \qquad ( 3 )$$

where θ(n) is the error coefficient at the n^{th} time, m is a number of data reuse, eₘ(n)=θ^{(m-1)}(n)e₁(n), e₁(n) is the error at a first reuse, eₘ(n) is the error at an m^{th} reuse, θ^{(m-1)}(n) is the error accumulation coefficient between eₘ(n) and e₁(n) at the n^{th} time, and θ^{(m-1)}(n) is an m−1^{th} power of θ(n), θ^{m}(n) is an m^{th} power of θ(n);

θ(n) is expressed as:

$$θ ( n ) = 1 - {X}^{H} ( n ) k ( n ) \qquad ( 4 )$$

where magnitudes of x(n) and k(n) are both L×1.

Further, the computation expression of the weight at the n^{th} time is as follows:

$$w ( n ) = w ( n - 1 ) + D ( n - 1 ) k ( n ) ϕ ( n ) {e}^{*} ( n ) \qquad ( 6 )$$

where (⋅)* denotes conjugate.

Further, the filter coefficient matrix R(0)=I_{L×L} at an initial time, the weight W(0)=0_{L×L} at the initial time.

The technical solution provided by the embodiment of the present disclosure may include the following beneficial effects:
through the above-described adaptive filtering algorithm for underwater acoustic channel estimation in the embodiment of the present disclosure, on the one hand, the idea of proportional matrix and data reuse are introduced in the algorithm, so as to compute the proportional coefficient corresponding to each tap in each iteration, thereby improving the applicability of the algorithm in a sparse environment; and the accumulated error term is obtained by reusing the input signal and the desired signal within the same time, further improving the accuracy of the algorithm. On the other hand, the accuracy of the recursive least squares algorithm is improved in the sparse environment, which is helpful to the efficient development of underwater acoustic communication research.

### BRIEF DESCRIPTION OF THE DRAWINGS

The attached drawings are incorporated into the specification and form part of this specification, showing embodiments that are consistent with the present disclosure and are used in conjunction with the specification to explain the principles of the present disclosure. Obviously, the attached drawings in the following description are only some of the embodiments disclosed in the present disclosure. For ordinary technicians in this field, other attached drawings can be obtained according to these attached drawings without creative work.

FIG. 1 shows a step diagram of an adaptive filtering algorithm for underwater acoustic channel estimation according to an exemplary embodiment of the present disclosure;

FIG. 2 shows a mean square error comparison diagram between a data-reusing proportion recursive least squares (DRPRLS) algorithm proposed in the present application and the existing algorithm in an exemplary embodiment of the present disclosure;

FIG. 3 shows a schematic diagram of a transmit frame structure in an exemplary embodiment of the present disclosure.

FIG. 4 shows a schematic diagram of a real channel in an exemplary embodiment of the present disclosure;

FIG. 5 shows an output constellation of frequency domain least mean square error equalization driven by a least mean square error (LMS) algorithm in an exemplary embodiment of the present disclosure;

FIG. 6 shows an output constellation of frequency domain least mean square error equalization driven by an improved proportional normalized least mean square error (IPNLMS) algorithm in an exemplary embodiment of the present disclosure;

FIG. 7 shows an output constellation of frequency domain least mean square error equalization driven by a recursive least squares (RLS) algorithm in an exemplary embodiment of the present disclosure;

FIG. 8 shows an output constellation of frequency domain least mean square error equalization driven by a proportional recursive least squares (PRLS) algorithm in an exemplary embodiment of the present disclosure;

FIG. 9 shows an output constellation diagram of frequency domain least mean square error equalization driven by a data-reusing recursive least squares (DRRLS) algorithm in an exemplary embodiment of the present disclosure;

FIG. 10 shows an output constellation of frequency domain least mean square error equalization driven by a DRPRLS algorithm in an exemplary embodiment of the present disclosure;

FIG. 11 shows a graph of a percentage in a bit error rate (BER) of a sea trial in an exemplary embodiment of the present disclosure.

### DETAILED DESCRIPTION OF THE EMBODIMENTS

Now with reference the attached drawings to describe the exemplary embodiment more comprehensively. However, the exemplary embodiment can be implemented in many forms and should not be understood as limited to the examples described here; by contrast, the provision of these embodiments makes this disclosure more comprehensive and complete, and conveys the idea of the exemplary embodiment to the technicians in the field in a comprehensive manner. The features, structures or characteristics described can be combined in one or more implementations in any appropriate way.

In addition, the attached drawings are only a schematic diagram of the disclosed embodiment, not necessarily drawn in proportion. The same captions in the attached drawings represent the same or similar parts, thus omitting repeated descriptions of them. Some of the block diagrams shown in the attached drawings are functional entities that do not necessarily have to correspond to physically or logically independent entities.

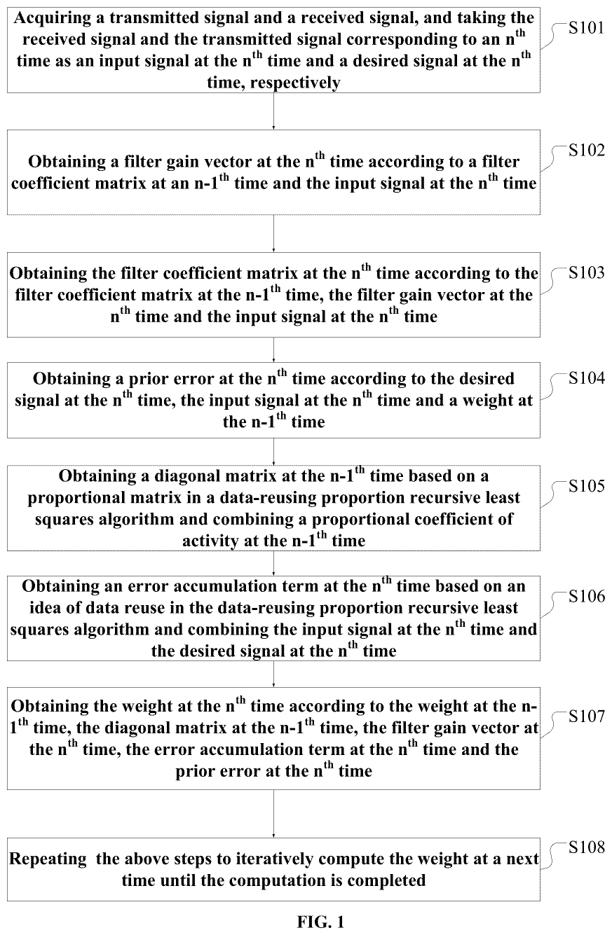

An adaptive filtering algorithm for underwater acoustic channel estimation is provided in the implementation of this example. As shown in FIG. 1, the adaptive filtering algorithm for underwater acoustic channel estimation can include: step S101-step S108.
step S101: a transmitted signal and a received signal are acquired, and the received signal and the transmitted signal corresponding to an n^{th} time are taken as an input signal at the n^{th} time and a desired signal at the n^{th} time, respectively; wherein a preset length of the input signal at the n^{th} time is L;
step S102: a filter gain vector at the n^{th} time is obtained according to a filter coefficient matrix at an n−1^{th} time and the input signal at the n^{th} time;
step S103: the filter coefficient matrix at the n^{th} time is obtained according to the filter coefficient matrix at the n−1^{th} time, the filter gain vector at the n^{th} time and the input signal at the n^{th} time;
step S104: a prior error at the n^{th} time is obtained according to the desired signal at the n^{th} time, the input signal at the n^{th} time and a weight at the n−1^{th} time;
step S105: a diagonal matrix at the n−1^{th} time is obtained based on a proportional matrix in a data-reusing proportion recursive least squares algorithm and combined with a proportional coefficient of activity at the n−1^{th} time;
step S106: an error accumulation term at the n^{th} time is obtained based on an idea of data reuse in the data-reusing proportion recursive least squares algorithm and combined with the input signal at the n^{th} time and the desired signal at the n^{th} time;
step S107: the weight at the n^{th} time is obtained according to the weight at the n−1^{th} time, the diagonal matrix at the n−1^{th} time, the filter gain vector at the n^{th} time, the error accumulation term at the n^{th} time and the prior error at the n^{th} time; and
step S108: the above steps are repeated to iteratively compute the weight at a next time until the computation is completed.

Through the above-described adaptive filtering algorithm for underwater acoustic channel estimation, on the one hand, the idea of proportional matrix and data reuse are introduced in the algorithm, so as to compute the proportional coefficient corresponding to each tap in each iteration, thereby improving the applicability of the algorithm in a sparse environment; and the accumulated error term is obtained by reusing the input signal and the desired signal within the same time, further improving the accuracy of the algorithm. On the other hand, the accuracy of the recursive least squares algorithm is improved in the sparse environment, which is helpful to the efficient development of underwater acoustic communication research.

In the following, the steps of the above-mentioned adaptive filtering algorithm for underwater acoustic channel estimation in the implementation of this example are described in more detail with reference to FIGS. 1-11.

In one embodiment, this present application proposes a data-reusing proportion recursive least squares (DRPRLS) algorithm, the algorithm introduces a proportional matrix to assign different weights to the active channel impulse response taps, so that the non-zero taps quickly converge to the true value, which improves the performance of the algorithm in the sparse environment. The expression of the proportional matrix at the n−1^{th} time is as follows:

$$D ( n - 1 ) = μdiag \{ {d}_{i} ( n - 1 ) \} , i = 1 , 2 , … , L \qquad ( 1 )$$

where, D(n−1) is the diagonal matrix with the magnitude of L×L, L is a filter length; μ is a parameter that weighs the convergence performance and steady-state performance of the algorithm, and μ is a control parameter, in order to ensure that the algorithm can converge, the value range of μ is generally (0, L]. dᵢ(n−1) is an activity proportional coefficient at the n−1^{th} time, the computation expression of dᵢ(n−1) is as follows:

$${d}_{i} ( n - 1 ) = \frac{1 - a}{2 L} + \frac{( 1 + a ) \vert {w}_{i} ( n - 1 ) \vert}{2 {‖ {w}_{L} ( n - 1 ) ‖}_{1} + ϵ} \qquad ( 2 )$$

where (1−a)/2L is a fixed proportional coefficient, a∈[−1,1) is a balance parameter, e is a small positive constant and used to prevent the denominator from becoming zero and causing numerical instability, ∥⋅∥₁ is a 1-norm. w_{L}(n−1) is an estimated channel impulse response vector at the n−1^{th} time, the magnitude is L×1, and wᵢ(n−1) is an i^{th} element in w_{L}(n−1).

In addition, this present application derives the error accumulation term and incorporates it into the weight update of the data-reusing proportion recursive least squares algorithm to further improve the accuracy of the algorithm, thus ensuring the accuracy of channel estimation. The conventional recursive least squares algorithm only uses the input signal x(n) and the desired signal u(n) once at the n^{th} time, the concept of data reuse involves the reuse of x(n) and u(n) at the n^{th} time to compute the error accumulation term φ(n). In this present application, the number of data reuses is denoted as m, and the relationship between φ(n) and m is:

$$ϕ ( n ) = \frac{1 - {θ}^{m} ( n )}{1 - θ ( n )} \qquad ( 3 )$$

where θ(n) is the error coefficient in the process of data reuse, specifically, eₘ(n)=θ^{(m-1)}(n)e₁(n), e₁(n) and eₘ(n) are the error at the first reuse and the error at an m^{th} reuse, respectively, θ^{(m-1)}(n) is the error accumulation coefficient between eₘ(n) and e₁(n) at the n^{th} time, and θ^{(m-1)}(n) is an m−1^{th} power of θ(n); a cumulative summation from 1 to m is performed on θ^{(m-1)}(n), that is,

$$ϕ ( n ) = {\sum }_{j = 1}^{m} {θ}^{j - 1} ( n ) ,$$

θ^{(j-1)}(n) is the j−1^{th} power of θ(n), j denotes an index from 1 to m, and the Formula (3) can be obtained by using the summation formula of isometric sequence, it can be seen that θ^{m}(n) is the error accumulation coefficient of m^{th} reuse.

In addition, θ(n) is expressed as:

$$θ ( n ) = 1 - {x}^{H} ( n ) k ( n ) \qquad ( 4 )$$

where magnitudes of x(n) and k(n) are both L×1. k(n) is the filter gain vector, generally, it takes x(n)=[x(n), x(n−1), . . . , x(n−L+1)].

The adaptive filtering algorithm for underwater acoustic channel estimation proposed in this present application is obtained by introducing the proportional matrix and the error accumulation term into the weight update of the recursive least squares algorithm.

In one embodiment, firstly, the conventional recursive least squares algorithm is:
at the n^{th} time, the weight update of the conventional recursive least squares algorithm is expressed as follows:

$$w ( n ) = w ( n - 1 ) + k ( n ) {e}^{*} ( n ) \qquad ( 5 )$$

where operation (⋅)* denotes conjugate.

Formula (5) estimates the channel impulse response coefficients. It can be seen that the conventional update method assigns the same weight to all taps in each iteration, so the main taps and those near-zero taps cannot be effectively distinguished in the sparse environment.

Secondly, the proportional matrix and error accumulation term are introduced:
compared with the conventional algorithm, the algorithm proposed in this present application needs to compute the proportional matrix and the error accumulation term according to Formulas (1)-(4), and then the two items are introduced into the weight update, that is, D(n−1) and φ(n) are substituted into Formula (5), and can be obtained:

$$w ( n ) = w ( n - 1 ) + D ( n - 1 ) k ( n ) ϕ ( n ) {e}^{*} ( n ) \qquad ( 6 )$$

compared with the conventional algorithm, this present application can assign proportional weights to different taps in real-time in the process of calculating the channel impulse response coefficient, and further improve its accuracy through data reuse. Table 1 is the pseudo-code of the adaptive filtering algorithm for underwater acoustic channel estimation proposed in this present application, where R(n) denotes the filter coefficient matrix with the magnitude of L×L; λ is the forgetting factor, generally with a value of 0<<λ<1; (⋅)^{H} denotes the conjugate transpose; N is the signal length.

TABLE 1
Pseudo-code of the adaptive filtering algorithm for
underwater acoustic channel estimation
Algorithm: an adaptive filtering algorithm for
underwater acoustic channel estimation

Initialization: R(0) = I_{L×L}, w(0) = 0_{L×1}
Input: x(n), u(n), ∈, a, λ, μ, m
Output: w(n)
for n = 1:N
$k ( n ) = \frac{{λ}^{− 1} {R}^{− 1} ( n − 1 ) x ( n )}{1 + {λ}^{− 1} {x}^{H} ( n ) {R}^{− 3} ( n − 1 ) x ( n )}$
R⁻¹(n) = λ⁻¹[R⁻¹(n − 1) − k(n)x^{H}(n)R⁻¹(n − 1)]
e(n) = u(n) − w^{H}(n − 1)x(n)
${d}_{i} ( n − 1 ) = \frac{1 − a}{2 L} + \frac{( 1 + a ) \vert {w}_{i} ( n − 1 ) \vert}{2 {‖ {w}_{L} ( n − 1 ) ‖}_{1} + ϵ}$
D(n − 1) = μ diag{dᵢ(n − 1)}, i = 1, 2, ... , L
θ(n) = 1 − x^{H}(n)k(n)
$ϕ ( n ) = \frac{1 - {θ}^{m} ( n )}{1 - θ ( n )}$
w(n) = w(n − 1) + D(n − 1)k(n)φ(n)e*(n)
end

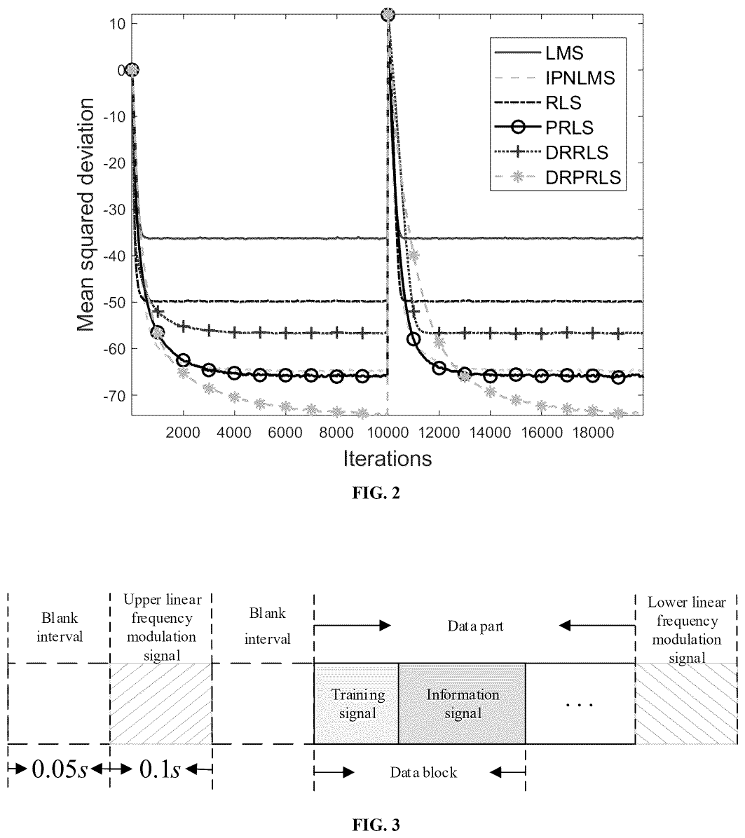

Finally, the steady-state mean square deviation and the driven bit error rate performance of the proposed algorithm are computed:
the steady-state mean square deviation is used as the criterion in the simulation, which is defined as follows:

$$MSD = 20 {log}_{10} \frac{{‖ w - h ‖}_{2}}{{‖ h ‖}_{2}} \qquad ( 7 )$$

where h is used as a reference channel impulse response vector, the magnitude is L×1. As shown in FIG. 2, the simulation results of the algorithm proposed in this present application is compared with other existing algorithms.

In the marine experiment, after using Formula (6) to estimate the channel impulse response coefficient, the frequency domain least mean square error equalization is used to recover the transmitted signal, and compared with the transmitted signal to obtain the bit error rate. The calculation formula of bit error rate is as follows:

$$BER = \frac{{n}_{r}}{{n}_{t}} \qquad ( 8 )$$

where nᵣ and nₜ denote the number of error bits and the total number of transmitted bits, respectively.

The frequency domain least mean square error equalization expression is as follows:

$$G ( k ) = {w ( k )}^{H} {( w ( k ) {w ( k )}^{H} + \frac{{σ}_{v}^{2}}{{σ}_{u}^{2}} \cdot I )}^{- 1} \qquad ( 9 )$$

where k denotes a frequency point,

$${σ}_{v}^{2} and {σ}_{u}^{2}$$

are the average power of the noise and the transmitted signal, respectively. The estimation of the transmitted signal can be computed by û(k)=G(k)X(k), and x(k) is the input signal in the frequency domain, which can be obtained by performing Fourier transform from x(n).

In a specific embodiment, the simulation conditions are as follows: the channel length L=60, the number of non-zero taps s=5, the signal length N=2×10⁴, and the signal-to-noise ratio is set to 20 dB. The non-zero taps and signals in the channel are randomly generated, following N(0,1) and N(0,1/s) distribution, respectively. The algorithm parameters used in the simulation are shown in Table 2, where all the algorithms mentioned are abbreviated in English, LMS: least mean square error; RLS: recursive least squares; IPNLMS: improved proportional normalized least mean square error; PRLS: proportional recursive least squares; DRRLS: data-reusing recursive least squares; DRPRLS: data-reusing proportion recursive least squares, that is, the algorithm proposed in this present application; wherein, v is the step size used for the LMS algorithm and the IPNLMS algorithm, and p is the control parameter.

TABLE 2
Algorithm parameters used in simulation

| | ν | λ | m | μ | α | ϵ |
|---|---|---|---|---|---|---|
| LMS algorithm | 10⁻² | \ | \ | \ | \ | \ |
| IPNLMS algorithm | 10⁻¹ | \ | \ | \ | 0.5 | \ |
| RLS algorithm | \ | 0.99 | \ | \ | \ | \ |
| PRLS algorithm | \ | 0.99 | \ | 12 | 0.5 | 10⁻⁶ |
| DRRLS algorithm | \ | 0.999 | 5 | \ | \ | \ |
| DRPRLS algorithm | \ | 0.999 | 5 | 12 | 0.5 | 10⁻⁶ |

The marine experiment was carried out in January 2024 in Wuyuan Bay, Xiamen, with an average water depth of 5-6 meters, the transmitting and receiving transducers are 700 meters apart and the water depth is 2 meters. The sampling rate of the transmitting end is 96 kHz, the effective bandwidth is 3.5 kHz, the roll-off factor is 0.1667, and the symbol rate is 3 kBaud/s. The data format in the sea trial and the channel structure of Wuyuan Bay are shown in FIGS. 2-3, respectively. The algorithm parameters are shown in Table 3.

TABLE 3
Algorithm parameters used in the sea trial

| | ν | λ | m | μ | α | ϵ |
|---|---|---|---|---|---|---|
| LMS algorithm | 10⁻⁴ | \ | \ | \ | \ | \ |
| IPNLMS algorithm | 2 × 10⁻¹ | \ | \ | \ | 0.5 | \ |
| RLS algorithm | \ | 0.999 | \ | \ | \ | \ |
| PRLS algorithm | \ | 0.999 | \ | 6 | 0.5 | 10⁻⁶ |
| DRRLS algorithm | \ | 0.999 | 5 | \ | \ | \ |
| DRPRLS algorithm | \ | 0.99 | 5 | 6 | 0.5 | 10⁻⁶ |

As shown in FIG. 2, it can be seen that the LMS algorithm has the lowest accuracy, followed by the RLS algorithm. The accuracy of the DRRLS algorithm is improved compared with the RLS algorithm, but it is still not as accurate as the PRLS and IPNLMS algorithms. The DRPRLS algorithm proposed in this application achieves the lowest steady-state mean square deviation.

As shown in FIG. 3, it is the schematic diagram of the transmit frame structure.

A total of 4.2×103 bits data are transmitted in the sea trial, the modulation scheme is quadrature phase shift keying, and a total of 4 frames of data are transmitted. The first three frames of the signal each frame includes 10 data blocks, each data block includes 3×102 training symbols, 1.2×103 information symbols, and the last frame includes 6 data blocks. The blank interval is used to prevent inter-symbol interference, and the function of the linear frequency modulation signal is to perform frame synchronization.

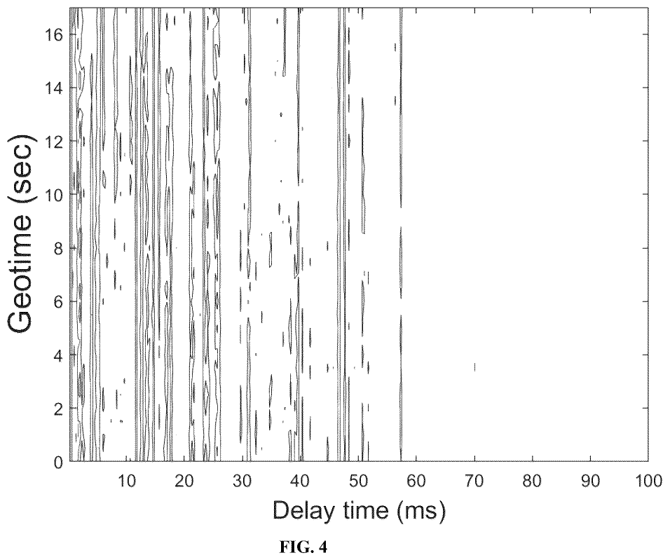

As shown in FIG. 4, it is the schematic diagram of the real channel.

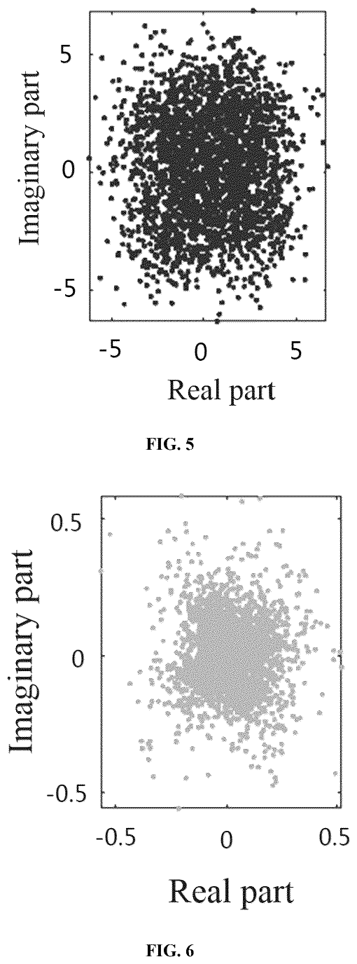

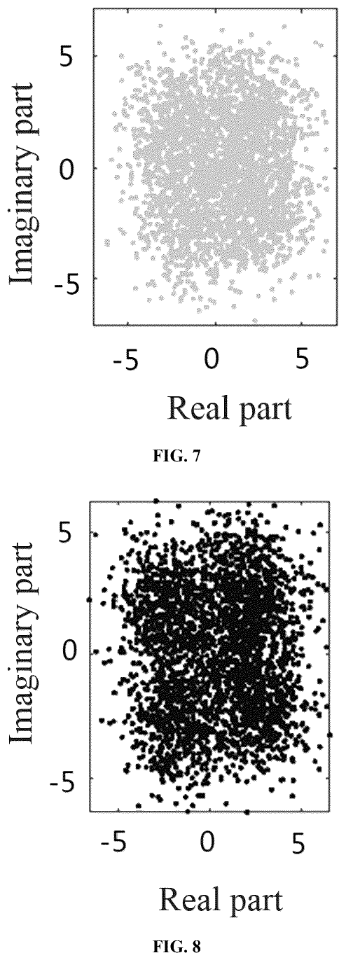

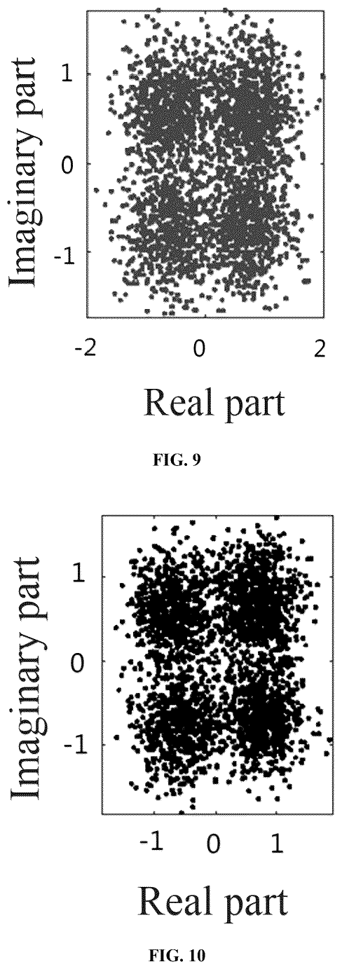

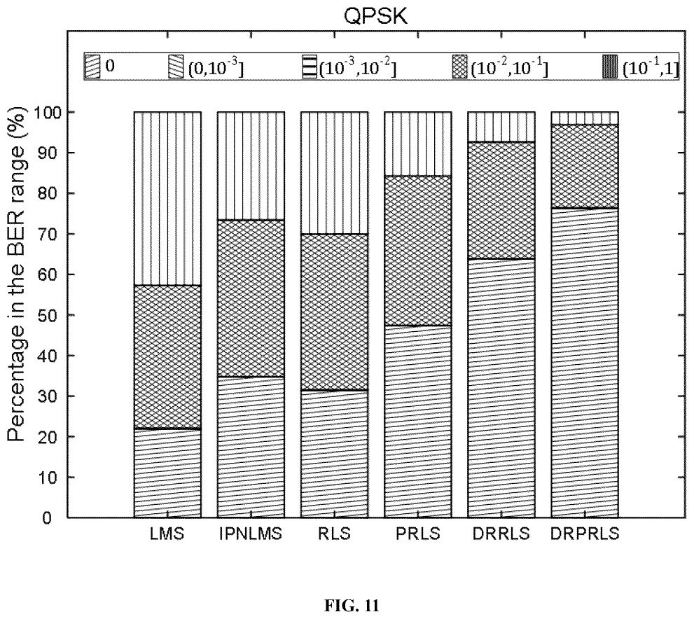

11 channel impulse response taps are taken as an example, the obvious multipath structure can be seen from FIGS. 5-10. Where FIG. 5 is the output constellation of frequency domain least mean square error equalization driven by the LMS algorithm; FIG. 6 is the output constellation of frequency domain least mean square error equalization driven by an IPNLMS algorithm in an exemplary embodiment of the present disclosure; FIG. 7 is the output constellation of frequency domain least mean square error equalization driven by the RLS algorithm; FIG. 8 is the output constellation of frequency domain least mean square error equalization driven by the PRLS algorithm in an exemplary embodiment of the present disclosure; FIG. 9 is the output constellation diagram of frequency domain least mean square error equalization driven by the DRRLS algorithm in an exemplary embodiment of the present disclosure; FIG. 10 is the output constellation of frequency domain least mean square error equalization driven by the DRPRLS algorithm in an exemplary embodiment of the present disclosure. The symbols after equalization are converged to the constellation points, and the larger distance between the constellation points denotes better communication performance. It can be found that the DRPRLS algorithm achieves the best performance by comparison.

In FIG. 11, different symbols denote different bit error rate intervals, for example, ‘/’ denotes the condition where the bit error rate is 0, and ‘|’ denotes the condition where the bit error rate is (10⁻¹,1]. The percentage of bit error rate is computed by slicing. All bits are divided into blocks of the same size and the bit error rate in each block is computed, finally, the percentage of each bit error rate is computed. Compared with other algorithms, the algorithm proposed in this present application has the optimal bit error rate, the proportion of the bit error rate of 0 is 76.3%, which is 44.9% higher than the proportion of the bit error rate of 0 of the RLS algorithm. The bit error rate of (10⁻¹, 1] is only less than 5%, which is the lowest among all algorithms.

It can be seen that the DRPRLS algorithm proposed in this present application is based on the conventional RLS algorithm, and the proportional coefficient and error accumulation term are introduced in the weight update, the whole process has theoretical support and a clear derivation process.

As shown in FIG. 2 of the simulation results, in the same sparse environment, the algorithm proposed in this present application achieves the lowest steady-state mean square error. As shown in FIGS. 5-10, which are the constellation diagrams of the least mean square error equalization in the frequency domain driven by different algorithms. It can be seen that the algorithm proposed in this present application has better communication performance than other algorithms. The sea trial results are shown in FIG. 11, and the DRPRLS algorithm proposed by this present application has the optimal bit error rate performance. This shows that the algorithm of this present application is feasible, it is more suitable for the sparse environment compared with the conventional algorithm, and the accuracy of the algorithm is improved under the premise of similarity guarantee convergence.

Through the above-described adaptive filtering algorithm for underwater acoustic channel estimation, on the one hand, the idea of proportional matrix and data reuse are introduced in the algorithm, so as to compute the proportional coefficient corresponding to each tap in each iteration, thereby improving the applicability of the algorithm in a sparse environment; and the accumulated error term is obtained by reusing the input signal and the desired signal within the same time, further improving the accuracy of the algorithm. On the other hand, the accuracy of the recursive least squares algorithm is improved in the sparse environment, which is helpful to the efficient development of underwater acoustic communication research.

Furthermore, the terms ‘first’ and ‘second’ are used only for descriptive purposes and cannot be understood as indicating or implying relative importance or implicitly specifying the number of technical features indicated. Therefore, the features that are limited to ‘first’ and ‘second’ can explicitly or implicitly include one or more of these features. In the description of this public embodiment, ‘multiple’ means two or more, unless otherwise expressly specified.

In the description of this specification, the reference terms ‘an embodiment’, ‘some embodiments’, ‘examples’, ‘specific examples’ or ‘some examples’ mean that the specific features, structures, materials or characteristics described by the embodiment or example are included in at least one embodiment or example disclosed in this specification. In this specification, the indicative expression of the above terms does not have to be directed at the same embodiment or example. Furthermore, the specific features, structures, materials or features described can be combined in an appropriate manner in any one or more embodiments or examples. In addition, technicians in this field can combine and combine the different embodiments or examples described in this specification.

After considering the specifications and the present inventions disclosed here in practice, it is easy for technicians in this field to think of other embodiments of this present disclosure. This application is intended to cover any variants, uses, or adaptive changes in this disclosure. These variants, uses, or adaptive changes follow the general principles of this disclosure and include public knowledge, common sense, or customary technical means in this technical field that are not disclosed in this disclosure. The instructions and implementation examples are only regarded as examples, and the true scope and spirit of this disclosure are pointed out by the accompanying claims.

What is claimed is:

1. An adaptive filtering algorithm for underwater acoustic channel estimation, comprising:
acquiring a transmitted signal transmitted by a transmitting transducer and a received signal received by a receiving transducer, and taking the received signal and the transmitted signal corresponding to an n^{th} time as an input signal at the n^{th} time and a desired signal at the n^{th} time, respectively; wherein a preset length of the input signal at the n^{th} time is L;
obtaining a filter gain vector at the n^{th} time according to a filter coefficient matrix at an n−1^{th} time and the input signal at the n^{th} time;
obtaining the filter coefficient matrix at the n^{th} time according to the filter coefficient matrix at the n−1^{th} time, the filter gain vector at the n^{th} time and the input signal at the n^{th} time;
obtaining a prior error at the n^{th} time according to the desired signal at the n^{th} time, the input signal at the n^{th} time and a weight of one tap of taps at the n−1^{th} time;
obtaining a proportional matrix at the n−1^{th} time based on a proportional matrix in a data-reusing proportion recursive least squares algorithm and combining a proportional coefficient of activity at the n−1^{th} time; wherein an expression of the proportional matrix at the n−1^{th} time is as follows:
$$D ( n - 1 ) = μ diag \{ {d}_{i} ( n - 1 ) \} , i = 1 , 2 , … , L \qquad ( 1 )$$
wherein D(n−1) is the proportional matrix at the n−1^{th} time, a magnitude is L×L, L is a channel length, p is a control parameter, and a value range of μ is (0, L], dᵢ(n−1) is the proportional coefficient of activity at the n−1^{th} time, and a computation expression of dᵢ(n−1) is as follows:
$${d}_{i} ( n - 1 ) = \frac{1 - a}{2 L} + \frac{( 1 + a ) \vert {w}_{i} ( n - 1 ) \vert}{2 {‖ {w}_{L} ( n - 1 ) ‖}_{1} + ϵ} \qquad ( 2 )$$
wherein (1−a)/2L is a fixed proportional coefficient, a∈[−1,1) is a balance parameter, ϵ is a positive constant, ∥⋅∥₁ is a 1-norm, w_{L}(n−1) is an estimated channel impulse response vector at the n−1^{th} time, a magnitude of w_{L}(n−1) is L×1, and w(n−1) is an i^{th} element in w_{L}(n−1);
obtaining an error accumulation term at the n^{th} time based on an idea of data reuse in the data-reusing proportion recursive least squares algorithm and combining the input signal at the n^{th} time and the desired signal at the n^{th} time; wherein a computation expression of the error accumulation term at the n^{th} time is as follows:
$$ϕ ( n ) = \frac{1 - {θ}^{m} ( n )}{1 - θ ( n )} \qquad ( 3 )$$
wherein θ(n) is an error coefficient at the n^{th} time, m is a number of data reuse, eₘ(n)=θ^{(m-1)}(n)e₁(n), e₁(n) is an error at a first reuse, eₘ(n) is an error at an m^{th} reuse, θ^{(m-1)}(n) is an error accumulation coefficient between eₘ(n) and e₁(n) at the n^{th} time, and θ^{(m-1)}(n) is an m−1^{th} power of θ(n), θ^{m}(n) is an m^{th} power of θ(n);
θ(n) is expressed as:
$$θ ( n ) = 1 - {x}^{H} ( n ) k ( n ) \qquad ( 4 )$$
wherein magnitudes of x(n) and k(n) are both L×1;
obtaining a weight of the tap at the n^{th} time according to the weight of the tap at the n−1^{th} time, the proportional matrix at the n−1^{th} time, the filter gain vector at the n^{th} time, the error accumulation term at the n^{th} time and the prior error at the n^{th} time; wherein a computation expression of the weight of the tap at the n^{th} time is as follows:
$$w ( n ) = w ( n - 1 ) + D ( n - 1 ) k ( n ) ϕ ( n ) {e}^{*} ( n ) \qquad ( 6 )$$
wherein (⋅)* denotes conjugate;
repeating above steps to iteratively compute a weight of the tap at a next time until computation of weight of the taps is completed.

2. The adaptive filtering algorithm for underwater acoustic channel estimation according to claim 1, wherein a computation expression of the filter gain vector at the n^{th} time is as follows:
$$k ( n ) = \frac{{λ}^{- 1} {R}^{- 1} ( n - 1 ) x ( n )}{1 + {λ}^{- 1} {x}^{H} ( n ) {R}^{- 1} ( n - 1 ) x ( n )} \qquad ( 10 )$$
wherein λ is a forgetting factor, and 0<<λ<1, R(n−1) is the filter coefficient matrix at the n−1^{th} time, x(n) is the input signal at the n^{th} time, and (⋅)^{H} is a conjugate transpose.

3. The adaptive filtering algorithm for underwater acoustic channel estimation according to claim 2, wherein a computation expression of the filter coefficient matrix at the n^{th} time is as follows:
$${R}^{- 1} ( n ) = {λ}^{- 1} [ {R}^{- 1} ( n - 1 ) - k ( n ) {x}^{H} ( n ) {R}^{- 1} ( n - 1 ) ] \qquad ( 11 )$$
wherein k(n) is the filter gain vector at the n^{th} time.

4. The adaptive filtering algorithm for underwater acoustic channel estimation according to claim 3, wherein a computation expression of the prior error at the n^{th} time is as follows:
$$e ( n ) = u ( n ) - {w}^{H} ( n - 1 ) x ( n ) \qquad ( 12 )$$
wherein w(n−1) is the weight of the tap at the n−1^{th} time, and u(n) is the transmitted signal at the n^{th} time.

5. The adaptive filtering algorithm for underwater acoustic channel estimation according to claim 4, wherein a filter coefficient matrix at an initial time is R(0)=I_{L×L}, and a weight of the tap at the initial time is W(0)=0_{L×L}.
